(19) United States
(12) Patent Application Publication
(10) Pub. No.: US 2014/0051053 A1
(43) Pub. Date: Feb. 20, 2014

(54) Method and Apparatus for Brain Development Training Using Eye Tracking

(71) Applicant: OHM Technologies LLC, Raritan, NJ (US)

(72) Inventor: Nishith Parikh, Raritan, NJ (US)

(73) Assignee: OHM Technologies LLC, Raritan, NJ (US)

(21) Appl. No.: 14/064,527

(22) Filed: Oct. 28, 2013

Related U.S. Application Data
(63) Continuation-in-part of application No. 13/031,928, filed on Feb. 22, 2011.
(60) Provisional application No. 61/340,510, filed on Mar. 18, 2010.

(51) Int. Cl. G09B 5/02

(52) U.S. Cl. CPC G09B 5/02
USPC 434/308

(57) ABSTRACT

Disclosed is a method and system for training brain development disorders involving impaired social interaction and communication. The system delivers audio-visual content, including varieties of lessons, instructions and tests for gradually improving neurological processing and memory through repetitive stimulation. The system and method maximizes effectiveness of learning by combining visual stimulation with reward delivery upon achieving goals. The system includes elements for module configuration, user validation, content delivery, user response/input including touch screen displays and eye tracking technology, and provides for real-time monitoring and feedback including altering delivered content. The configuration engine includes a progress module which monitors a user's performance on learning, review and/or test modules and changes lessons based on monitored performance. Recording and monitoring both subject behavior and display changes allows real-time alteration of lessons and stimuli.

### RELATED APPLICATION

This application is a continuation-in-part of U.S. patent application Ser. No. 13/031,928 filed Feb. 22, 2011, which claims priority from U.S. Provisional Application No. 61/340,510 filed Mar. 18, 2010, the disclosures of which are hereby incorporated by reference in their entireties.

### BACKGROUND

The disclosed method and system relates to education of human subjects, and more specifically to training a brain development disorder involving impairment of communication and social interaction skills, such as for example, autism. The method and system allows full integration of a comprehensive animated display for delivering training program content to a subject optionally having touch screen capabilities and/or equipped with eye-tracking technology, with reward delivery, monitoring unit and recording unit. The disclosed method and system has been shown to be particularly effective at training and tracking brain stimulation and attention of subjects in need thereof, including those with autism, Asperger syndrome and PDD-NOS (Pervasive developmental disorder not otherwise specified).

It is well known that autistic children display defects in their social skills, but not in skills which lack a social or communication component. Standard teaching environments with teachers, instructors and other students thus may actually be detrimental to the advancement of an individual with such a developmental disorder. There are few standalone supportive technologies available for these subjects. The inventive system and method is configured to provide therapeutic educational intervention, while allowing monitoring, mass data collection and analysis, optionally in real time, while eliminating such drawbacks.

There has thus been a need in the art to develop a method and apparatus that allows a subject is drawn to predictable, rule-based systems, whether these are repeating patterns in the trial/game/lesson and utilize autistics subject's affinity towards lawful repetitions, while simultaneously allowing adjustment of content in real time based on feedback or input from a user, optionally by tracking eye movement.

The method and system may employ touch screen and/or eye tracking technology with colorful customized animation on a display and significantly enhances the ability of the training material to provide needed educational interventions while allowing instructors access to the lesson and the ability to initiate changes in curriculum based on feedback from a subject in real time.

### BRIEF DESCRIPTION OF THE DRAWINGS

FIG. 1 is a system diagram of a computer system for executing a program according to the present invention;

FIG. 2 is a process diagram of the method of the training for the present invention;

FIG. 3 is a system dataflow diagram showing flow of the date from various components of the system;

FIG. 4 is a system workflow diagram showing flow of activities in the proposed sequence;

FIG. 5-A is a prototype of a kiosk based apparatus with integrated delivery system to deliver the method of the present invention;

FIG. 5-B is a prototype of a kiosk system with independent unit of the delivery system for the present invention;

FIG. 6 is a flow diagram of the activity delivery process explaining process of user validation to the award delivery;

FIGS. 7A and 7B illustrate a flow diagram explaining delivery of the training activity management based on the performance and the skill level;

FIG. 8 illustrates how the sound will be modified for users at the lower skill level;

FIG. 9 is a pictorial presentation of sample activities;

FIG. 10 illustrates how the system will be utilized in a different environment for delivering same activities at different time;

FIG. 11 illustrates a sample activity of “Touch and Show” title screen;

FIG. 12 illustrates a sample activity “Touch and Show” the teaching training on a selected topic;

FIG. 13-A illustrates a sample activity “Touch and Show” training on how to play the activity using the system and apparatus by utilizing audio and video based instructions;

FIG. 13-B illustrates a sample activity “Touch and Show” training on how to play the activity using the system and apparatus by utilizing only visual presentation using video;

FIG. 14 illustrates the actual activity;

FIG. 15 illustrates a sample successful completion of the activity module using several attempts;

FIG. 16 illustrates score tracking method;

FIG. 17 illustrates a sample visual presentation of the score and reward system;

FIG. 18-A and FIG. 18-B illustrates how the customization can be done for the activity based on the subject's likings;

FIG. 19 and FIG. 20 illustrates step by step process of the sample activity; and

FIG. 21 is a flowchart generally depicting the disclosed training method with eye tracking technology.

### DETAILED DESCRIPTION

The disclosed method and system are used to improve a subject's learning ability by utilizing a computer/kiosk system and reducing the social the element from the intervention. The method provides a plurality of content types in terms of training skill levels, subject or subject's known individual's avatar or picture, voice, topics of interest and/or content of the subject's interest. This plurality differs from each other in the form of animated content, and in the amount of audio processing applied to the speech commands and/or information. The method also selects from the plurality of content type based on the needs and training skill level to be presented to the subject that is associated with, or corresponds to, the subject's ability.

The method is presented to the subject on a computer and interacts with the subject via input/output devices like camera, touch screen, ID card, mouse, keyboard, joystick, fingerprint scanner, paper scanner, motion detector, eye tracking unit, or any body movement detecting device on the computer. The method utilizes the information from the input devices to calculate the needs of the subject and change the type, quality, method, color, audio and/or visual presentation delivered to the subject. The method further presents as a trial, an audio/visual commands/information from a set of animation and speech commands/information from the selected skill level. The speech command directs the subject to manipulate at least one of the pluralities of graphical components. If the subject correctly manipulates the graphical components, the method presents another trial. If the subject incorrectly manipulates the graphical components, the method presents another trial without giving any discouraging message. As the subject correctly manipulates the graphical components, new audio/visual command/information from the set of animation and speech command/information from the library gets delivered to the subject based on the skill and needs of the subject. And, as the subject incorrectly manipulates the graphical components, the complexity of the trial using audio/visual commands/information is decreased and the entertaining animated content increased. The method is also an attention span measuring tool. The tool measures the subject's attention span utilizing a motion detector and reads an eye movement using a video camera. Based on the historical attention span of the object, before the expiration of the attention span the method changes the content type delivered to the subject from educational content to the entertaining content of the subject's interest. Once the attention is gained, the method delivers new audio/visual command/information from the set of animation and speech command/information from the library to the subject.

In another aspect, the present invention provides a method to improve the cognitive processing system of a subject. The method provides a plurality of stimulus sets, with each of the plurality of stimulus sets having a plurality of command/information sentences. The method also provides a plurality of target graphical images and animation, each of the animation associated with a different one of the plurality of command/information sentences. The method further provides a plurality of distracter images that are not associated with the plurality of command/information sentences. The method then presents to the subject one of the plurality of command/information sentences from one of the plurality of stimulus sets to the subject, the presented sentence modified acoustically, and presents to the subject a target graphical image, from the plurality of target graphical images, that is associated with the presented command/information sentence. Along with the presented target graphical image the method presents a plurality of distracter images. The subject is then required to distinguish between the presented target graphical image, and the presented plurality of distracter images by selecting the target graphical image associated with the presented command/information sentence. Upon successful completion of the one or multiple trials, the subject will be awarded by some object, toy, food, or item of interest. In yet another aspect, the present invention provides an adaptive method to improve a subject's willingness to learn the offered topic.

The method according to the present invention utilizes a computer to process and present animated content with sound to the subject. This method utilizes the World Wide Web network or the local area network to retrieve animated content from the content storage server.

The method displays a plurality of animated images on the computer, the graphical images associated with information and/or some activities related to the topic of interest for the subject.

The method associates in pairs the plurality of animated images with particular activity and/or events such that two different animated images are associated with a particular activity and/or event. Upon the subject's selection of any of the plurality of animated images, its associated activity and/or event is presented. The method then requires the user to discriminate between the presented activities and/or events by sequentially selecting two different graphical images from among the plurality of graphical images, that are associated with the particular activities and/or event. The audio command/information is modified by stretching them in the time domain by varying amounts to make easy to understand for the object. As the subject correctly remembers the activities and/or event at one skill level, the amount of stretching applied to the audio command/information is reduced. In addition, as the subject correctly remembers the activities and/or events, the number of animated image pairs presented to the subject increases, requiring the subject to better train his/her understanding on the activity.

This 3D Animated Interactive Individualized Therapeutic Learning Technology for Autistic students will effectively utilize realistic colorful 2D/3D animation with individualized attractive audio effect for intervention. This technology driven approach utilizes various interventions and approaches to measure the effectiveness on different child with ASD. The key technology used is an application delivering educational animation inside a touch screen Kiosk system with camera/s that tracks eye and body movement of the Student to achieve bidirectional activities. Teachers set up the individualized training plan and can track the development progress and help the student to communicate better to develop independent daily living skills. This learning tool utilizes the artificial intelligence to help students with learning disabilities and may help improve their social behavior (because the student is not dealing with individual where they have to make eye contact). This technique utilizes the technology to provide consistent training for extended hours in the same environment. By using the repetitive activities with the Student using the Kiosk based system, teachers can collect the data of the behaviors and response from variety of content like different colors, animation, instructions, audio-music and special effects.

In the general education field, the technology is widely utilized but in the area of Autism the technology is underutilized. The model of a Social Learning Pal not only teaches social skills but also helps the researchers collect data for further analytical purposes for the betterment of the students, the families and the teachers.

This dual purpose technological solution is utilized in the following settings:
Schools Providing Education to students with ASD
Research Institutes doing research on Autism
Hospitals and home for parents

According to another aspect, the method is implemented in three phases comprising phase I, phase II and phase III. The key activity during phase I is collecting, populating and verifying subjects' profiles. All the master data for the institute providing this training to the subject is also populated during this phase. Students' Profile development process is done in three steps.

### 1. Collecting Profile Information Includes:

a) Personal Info such as Name, Parent Name, Date of Birth, Picture etc.
b) Collect photographs of family members and individuals known to the subject for various activities
c) Contact Info such as Email ID, Telephone, Mobile, Residential Address
d) Current Problem/Disorder Info
e) Existing Abilities/Skills
f) Preferences
g) Phobia/Sensitivities
   2. Input students Profile—The Info gathered in step 1 is fed in the database.
   3. Verifying Profiles—The data fed in the database is verified by the authorities.

The phase II generates institute profile

1. Collecting Institute's Profile Info. Includes
a) Name, Contact, Introduction, Web Address, E-Mail Addresses
b) Name and Details of Support, Teaching Staff
   2. Input Institute Profile—The Info gathered is fed in the database.
   3. Verify Institute Profile—Get the Input data verified by the authorities.

In phase II, the right activities for the Students are selected based on their profile by experts. Once the activities are selected, based on the available and collected profile customization of the activity is programmed and configured. Selecting activity process analyzes the profile and selects the suitable activities for the subject. Selected activity is assigned and programmed in the system to the student after reviewing the individual's profile.

a) Capturing Customization Data—During this stage customized data like pictures of familiar people of the students for the activity—‘Identifying familiar people’, are captured and finalized.
b) Compose and Assign—The Trainer Administrator or Teacher composes and customizes selected activities and assigns it to right student.

Phase III is the final stage of the implementation where the subject carry out the activities assigned and programmed. Their performance, progress and acceptance are tracked and analyzed. Following steps are followed as part of the implementation:

1. Operational Setup—This includes the installation and setup of required Hardware/Software.
2. The launch—The Students carry out the assigned activities.
3. Tracking—Progress and performance of students is automatically tracked by the application.
4. Feedback Capture—Feedback from the stakeholders (Teachers/Students/Parents) is captured.
5. Analysis and Documentation—The information related to progress and performance of students will be analyzed and the results documented. Similarly the feedback received is also be analyzed and the outcome of this analysis is documented.

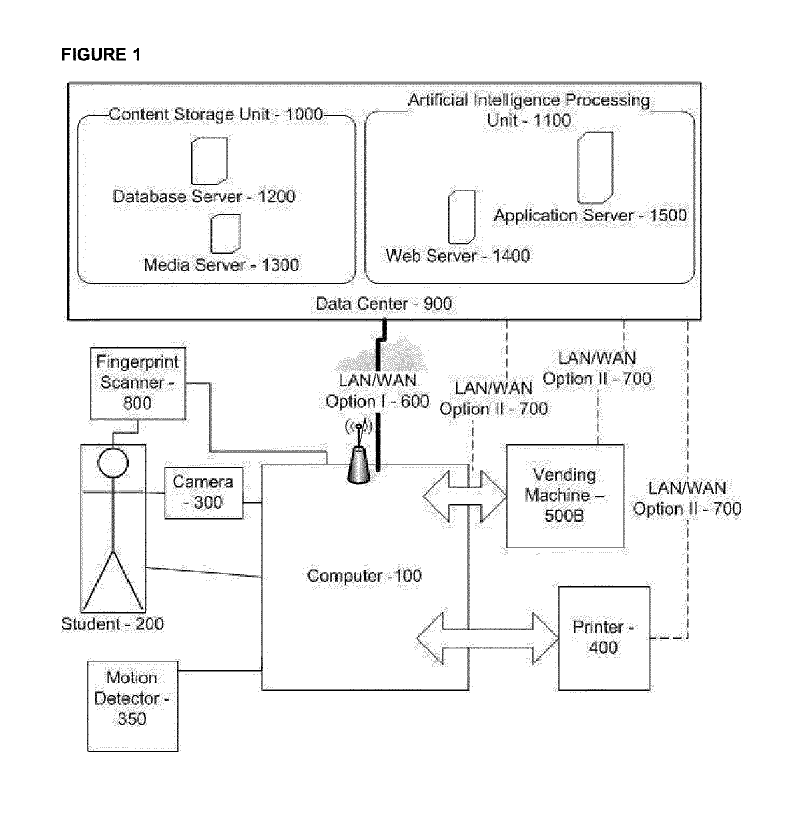

Referring to FIG. 1 is a system diagram comprising a computer system 100 for executing training for the brain development disorder in a subject, according to the present invention. The computer system 100 contains a computer having a CPU, memory (not shown), hard disk (not shown) and CD ROM drive (not shown), attached to a touch screen monitor. The monitor provides visual prompting and feedback to the subject during execution of the computer program. Also the monitor captures the response from the user using touch screen technology. Attached to the computer are a keyboard, speakers, a mouse, and headphones. The speakers and the headphones provide auditory prompting and feedback to the subject during execution of the computer program. The touch screen is used to navigate through the computer program, and to select particular responses after visual or auditory prompting by the computer program. In some cases mouse is used for the above purpose. The keyboard allows an instructor to enter alpha numeric information about the subject into the computer. Although a number of different computer platforms are applicable to the present invention, embodiments of the present invention execute on either IBM compatible computers or Macintosh computers. The finger print scanner 800 validates the subject (student) 200 and based on the identity of the subject load the profile of user in the computer program. The camera 300 tracks the activities of the subject and records the video for further analysis. The motion detector 350 detects the motion of the subject. The printer 400 prints the printable rewards and the result of the subject's progress. A printer 400 is shown connected to the computer 100 to illustrate that a subject can print out reports and rewards associated with the computer program of the present invention.

Vending machine 500B delivers the physical object based reward to the subject based on the learning program in a computer program. LAN/WAN Option I 1600 connects the computer system to the Data center 900 using wireless network and the LAN/WAN option II 700 uses wired network. The computer network allows information such as animated content, test scores, game statistics, and other subject information to flow from and to the subject's computer 100, to a server in the data center 900. Data center 900 contains storage unit 1000 and artificial intelligent processing unit 1100. The storage unit 1000 has two servers Database server 1200 and Media server 1300. These servers are utilized to store the media used by the computer program. This media includes audio, video and text based media for training. Artificial intelligence unit 1100 has two servers, web server 1400 and application server 1500. Web server 1400 delivers training content to the subject using the internet or LAN/WAN network. The application server 1500 generates deliverable content for the web server using the animated audio and video media delivered by the storage unit.

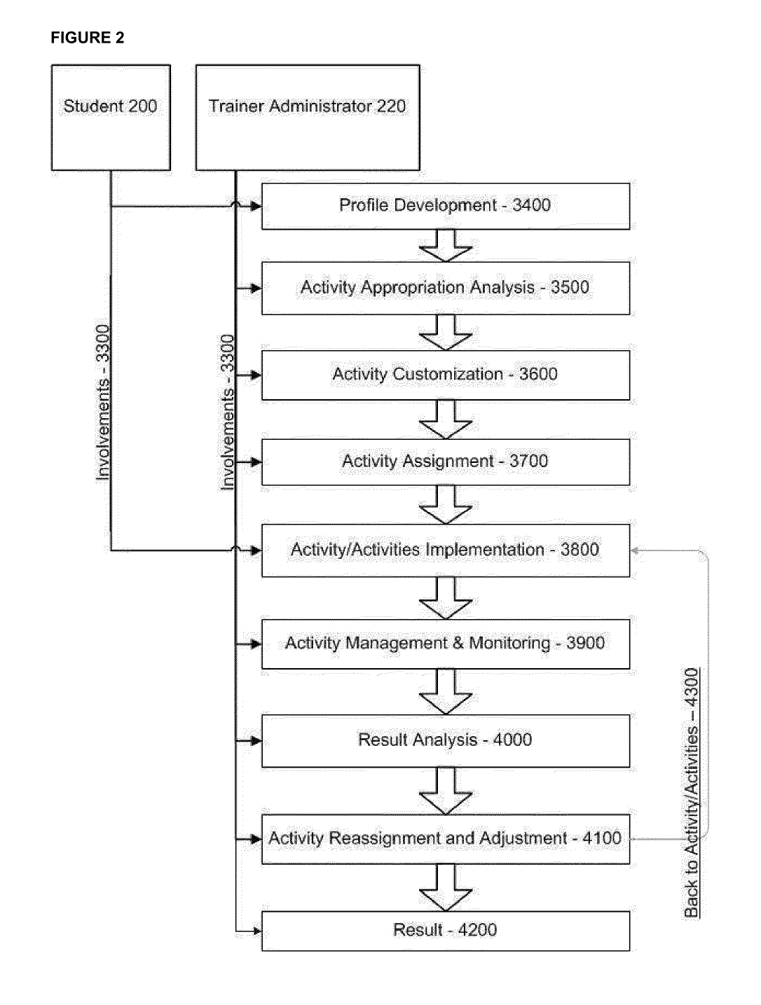

Now referring to FIG. 2, is a method of training. The subject 200 and the Trainer Administrator 220 are involved 3300 with various phases of the method. The Profile Development 3400 phase of the present invention is managed by the Trainer Administrator 220. Trainer Administrator creates the profile of the subject in terms of their likings, disliking, nature, gender, age and family background.

The phase II of the proposed method is the Activity Appropriation Analysis 3500. This is done by the Trainer Administrator. Based on the profile and subject's knowledge proficiency on the topic, Trainer Administrator creates a lesson plan using the library of the offered activities. Based on the lesson plan developed by the Trainer Administrator, the next phase would be to Activity Customization 3600 for the subject using the library of objects and audio visual components to develop customized activity. The Activity Assignment 3700 phase assigns the assignment activity to the subject for implementation. In this phase the subject is scheduled for training using the assigned activities in an activity module form. Multiple activities are assigned in an activity module form to the subject for scheduled delivery on a daily basis. The Trainer Administrator reviews the information on a computer and can upload configuration and control information pertaining to a particular subject. The Activity Implementation 3800 phase is the actual execution of the planed activity under the supervision of the Trainer Administrator. In the Activity Implementation phase 3800, subject uses the proposed software program on a daily basis for a planned fix time. Based on the programmed profile and assigned assignment, the subject goes to the next level of complexity and type of the activity. Once all the activity assigned are successfully completed based on the programmed parameters, the subject gets graduated for the assigned activity module. Throughout the Activity Implementation 3800 phase, the Trainer Administrator may manage and monitor the progress of the subject using the opposed computer program in real-time or substantially real-time. This phase is the Activity Managing and Monitoring phase 3900. The Result Analysis 4000 and Activity reassignment and adjustment 4100 get the subject to the final Result 4200. The Trainer Administrator may remotely initiate changes to the content delivered to the Subject in response to observed feedback from the Subject. Data observed and collected includes that from touch screen input by the Subject, the Subject's mannerisms, observed attention span of the Subject, as well as eye tracking feedback (as will be discussed in greater detail below).

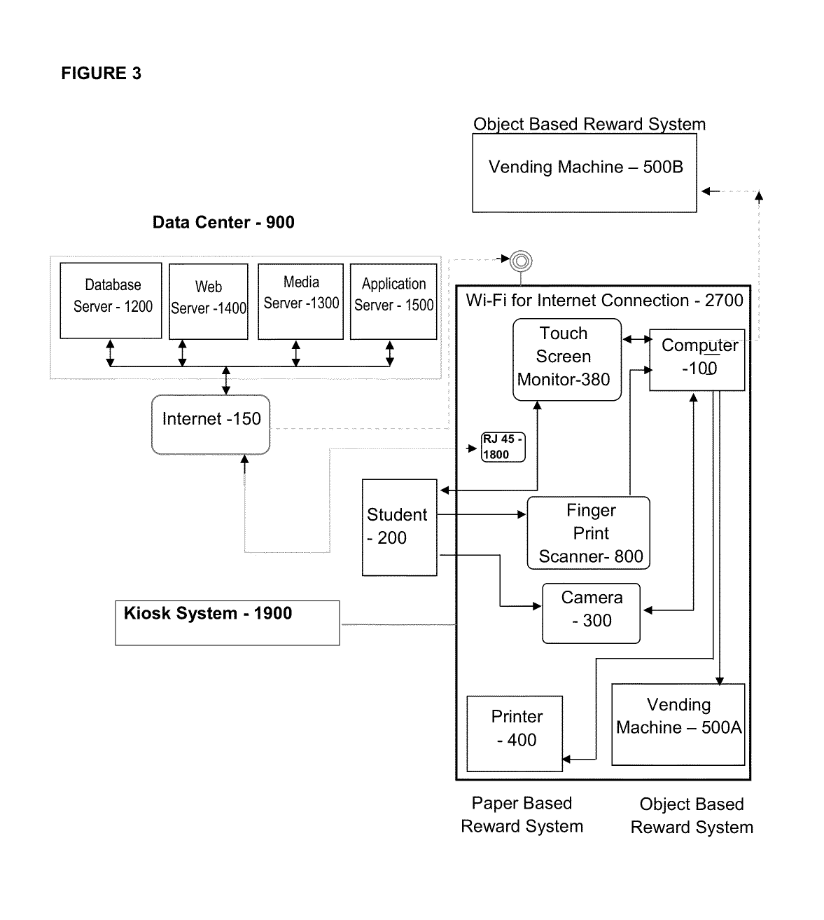

Referring to FIG. 3 is a system data flow diagram that illustrates the data flowing between the student subject and the proposed apparatus for training. Student 200 sends the finger print information to the fingerprint scanner 800. The finger print scanner 800 sends the captured data to the CPU. The CPU is connected to the data center 900 through internet 150. Using the internet connection CPU sends request to the web server 1400 in the data center 900 for the user validation. Request from the web server 1400 send request to the application server 1500 which sends request to the database server 1200 for user validation. Upon the successful validation of the user, the message gets delivered to the CPU. The delivered message from the CPU gets displayed on the touch screen monitor 380. Based on the configuration of the activity assigned to the subject, content gets delivered to the touch screen monitor 380 by the web server 1400 and the media server 1300. Camera 300 monitors the movement of the subject (student) 200 and the motion gets recorded in to the CPU which gets transferred and stored to the server 1300.

Upon completion of the activity, CPU gets request from the application server 1500 to deliver the reward to the subject. Based on the request received from the application server 1500, the request to the printer 400 or object based reward system or object based reward system gets transferred for the reward delivery to the subject.

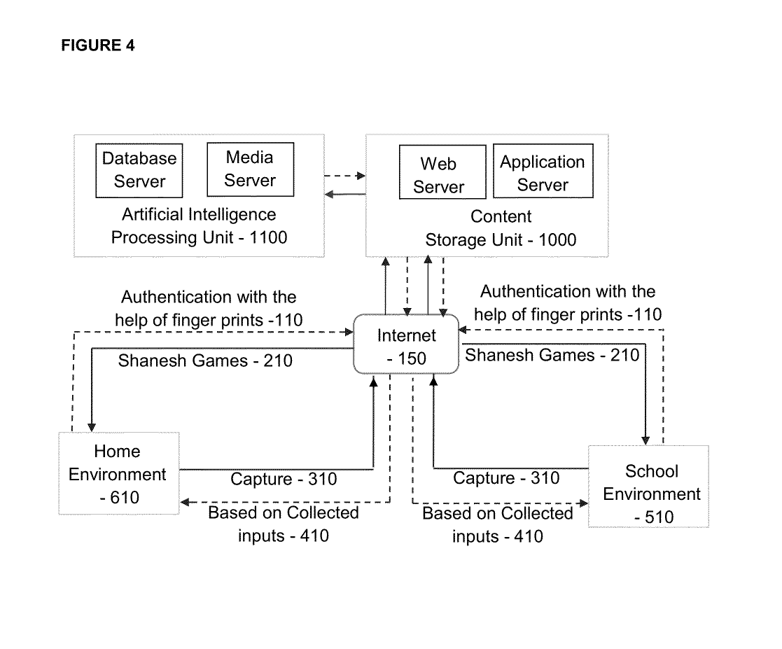

Referring to FIG. 4 is a workflow diagram that illustrates the step by step work flow. Step 1 is the authentication 110 using the login screen or using biometric technology. The date gets transmitted to Web server 1400 and Application server 1500 using the internet 150. Upon successful authentication of step 2, the assigned activity with the assigned training and entertaining content 210 starts delivering to the subject. The subject's (student) input using the input devices like touch screen, keyboard and mouse along with the movement of the subject using the camera is captured 310 and delivered to the Web server 1400 and Application server 1500 in the step 3. In step 4, based on the input 410 collected from the subject, the response, more content, report, result, animated customized content is delivered. Home environment 610 and school environment 510 shows the same activity and activity modules are accessed from the different location using the different hardware device using internet 150. If the subject is using the system from the home environment 610 where the object based reward system as illustrated in the FIG. 3 is not available, the subject will have an ability to print the credit for reward using any printer connected or save the credit proof for the future claim with the Trainer Administrator for their reward.

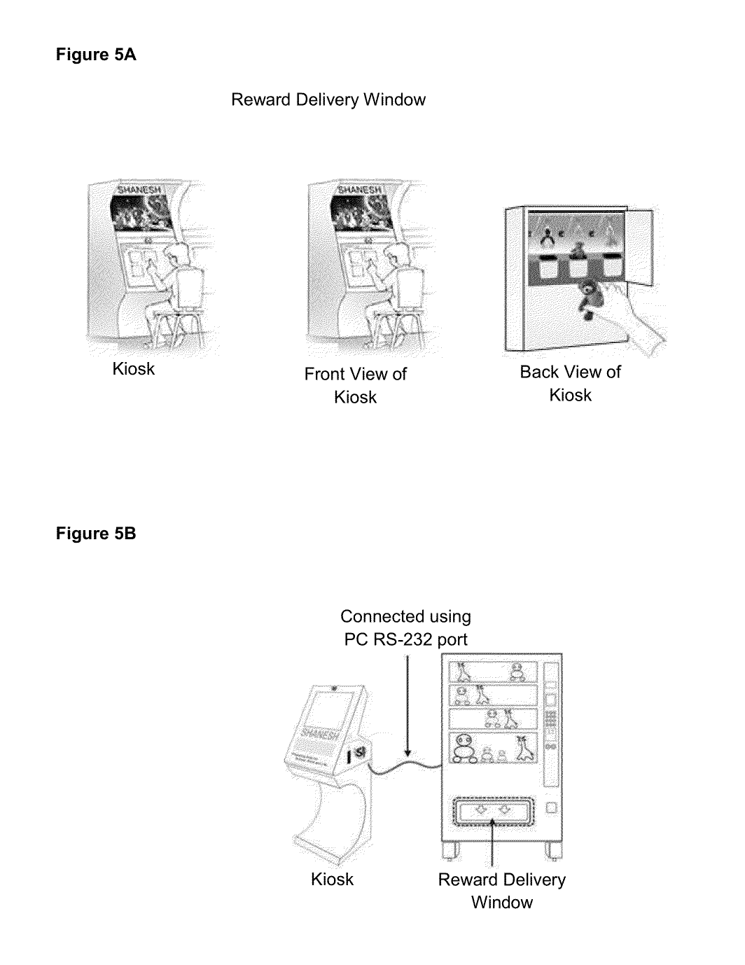

Reference is then invited to FIG. 5-A that illustrates the prototype of a Kiosk based apparatus. The Kiosk system comprise of CPU, touch screen monitor, camera, fingerprint scanner, network interface card, printer and machine for the delivery of the physical object for the reward delivery mechanism. The Kiosk system has an open slot in the front for the delivery of the reward. In the back of the apparatus there is a window for loading and unloading the physical object for the reward.

Referring to FIG. 5-B that illustrates the prototype of the Kiosk system with delivery machine connected through the RS-232 port. The Kiosk system is connected through the RS-232 port to the delivery machine with a reward delivery window. The reward delivery machine has object loading window in the back of the cabinet similar to the FIG. 5-A. For a large size user group, this type of the model is used where more objects like toys, candy, food or any tangible item based on the liking of the subject is stored and displayed. Based on the likings of the subject (student), Trainer Administrator load these tangible items in the delivery machine, which is delivered to the subject upon meeting the performance criteria set by the Trainer Administrator. Based on the settings set by the Trainer Administrator, the subject selects the desired item from the delivery machine as a reward. In some case, based on the Trainer Administrator's set preferences the item is visible or not visible to the subject where Trainer Administrator wants to keep the reward surprise to the subject. The system of the present invention also uses the printer and delivery system connected to the network. Based on the parameters set by the Trainer Administrator, the system prints the printable reward on the attached printer.

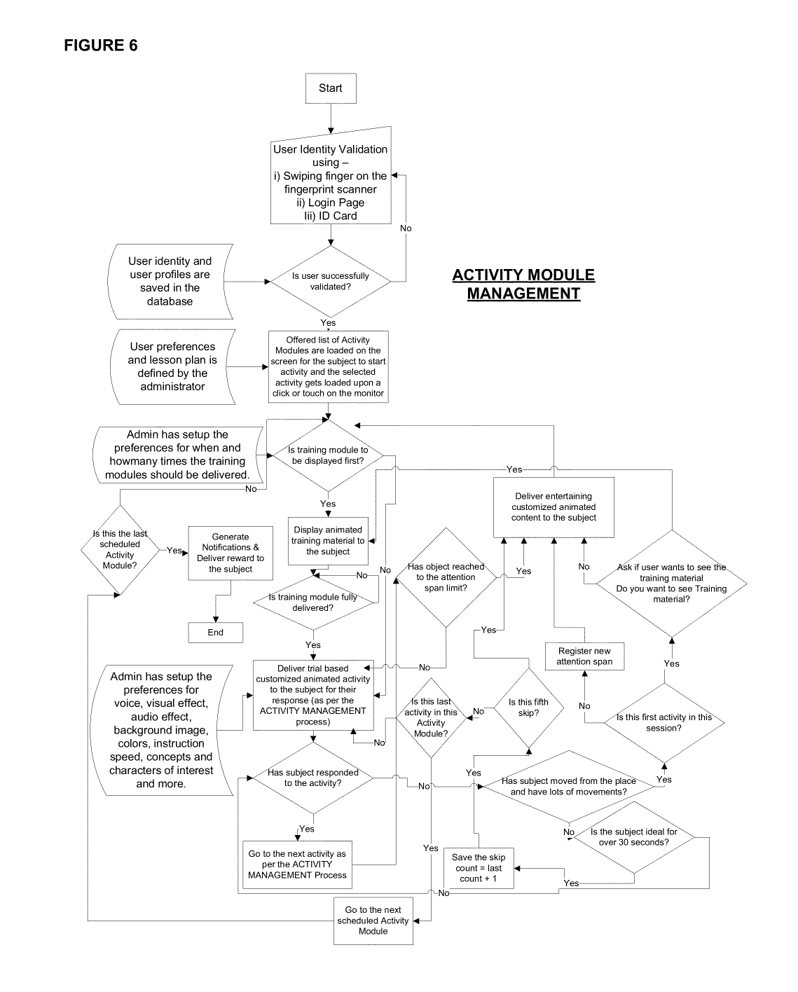

Reference is then made to FIG. 6 that illustrates the flow diagram of an activity module management process. User swipe the figure on the finger print scanning device or ID card or login using the login ID and password using the graphical user interface delivered on a touch screen monitor. Trainer Administrator has created and saved users profile in the database for validation. Upon successful validation the activity modules gets loaded on the users screen. First activity module gets loaded from the list of the activities modules assigned to the subject by the Trainer Administrator. First check is to see if there is a need of delivering training material related to the loaded activity module. If the training material is configured by the Trainer Administrator, the animated training material using the audio visual effect gets delivered. This training material is customized for the subject based on the profile and customized content programmed for the subject. After completion of the training module, the trial based activity from the activity list for the selected module gets delivered to the subject. After the delivery of the content, system waits for the response from the subject. While waiting, the system monitors the subject's movement using the video motion detector. If the user has moved from his place and if this is the first activity in this session, system asks subject if there is an interest in reviewing the training material again. If the response is no or is there is no response from the user, system will deliver some entertaining content to the subject. At the end of the entertaining content, the next module gets loaded for the next delivery. If the user requests for the training material, the training material for the active activity module gets loaded. If this is not the first activity and motion gets detected after the delivery of the activity without any response, the new attention span gets registered. When the response to the activity is received and before going to the next activity, attention span gets checked. If the attention span of the subject is reached in this session, the entertaining content gets delivered to the subject and the session time gets reset for the delivery of the next activity. After delivery of the activity, if the subject is idle for over 30 seconds without any movement, the next activity in the module gets delivered. If there are 5 skips in the current session, the entertaining content gets delivered to grab the attention of the subject. When the last activity gets delivered to the user, the system loads the next activity module from the assigned modules. If all modules are delivered successfully, the system delivers visual, printed or object based reward to the object. Upon successful completion of the activity module the system will sent notifications to all the individuals involved with the training including Training Administrators by email, text or instant messenger tool. System utilizes off-the-shelf instant messaging technology customized and integrated to this system for instant notification of rewards.

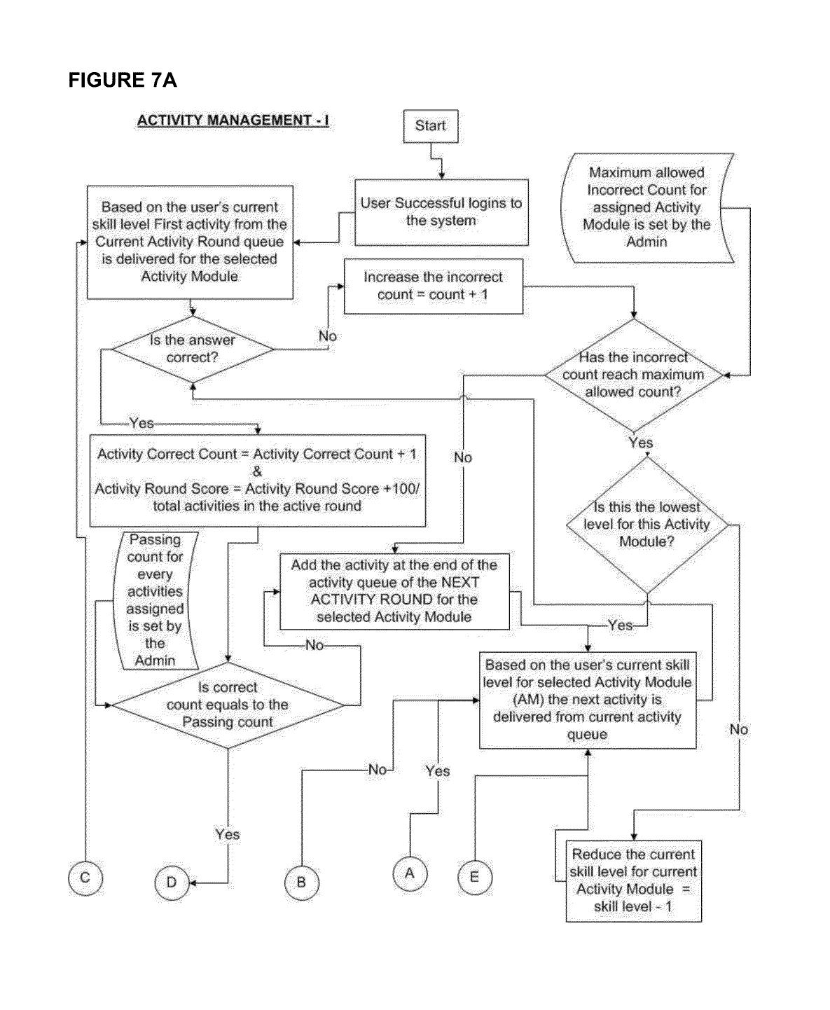

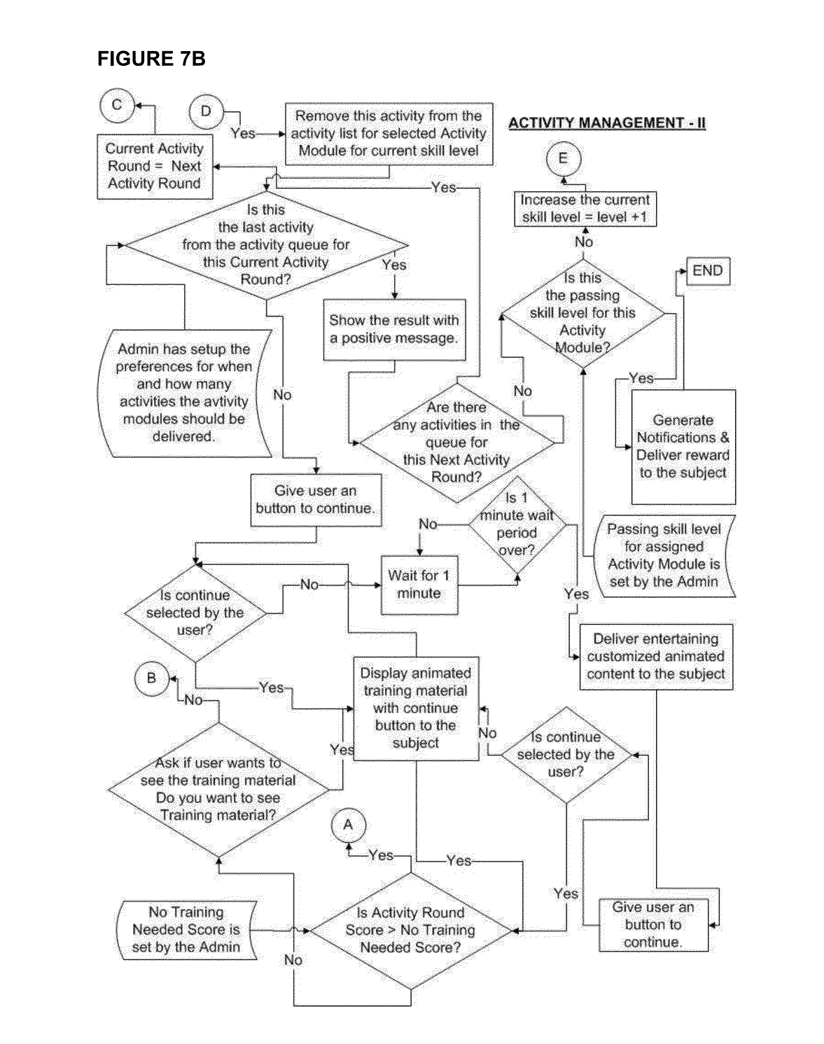

Reference is then made to FIGS. 7A and 7B that illustrate the flow diagram of activity management and skill level management process for the activity module. After the successful login to the system, the first activity module from the assigned modules gets loaded. The default first skill level for the current activity module is used to deliver the first activity from the activity module. If the answer is incorrect, the incorrect count gets incremented by one till it reaches to the maximum incorrect allowed for the current activity module. Once it reaches the maximum allowed incorrect answers for the current module, system changes the skill level to one skill level down for the module. The incorrect activity gets added for the next round of the activity for the same skill level. If the answer is correct, the correct count for this activity gets incremented till it reaches to the passing count for this activity. When it reaches to the passing count, the activity gets removed from the current activity module for the current level. If this is the last activity for this round, next activity round gets loaded.

After end of the each activity round, the activity round score is checked against the No Training Needed count. If the Activity round score is greater than No Training Needed count, the training content delivery is skipped. After end of the each activity, if continue is not selected by the subject, after 1 minute entertaining customized animation is delivered to get the attention of the subject. When the activity round is finished with all activities successfully removed from the current skill level and maximum passing skill level is reached, the reward is delivered to the subject.

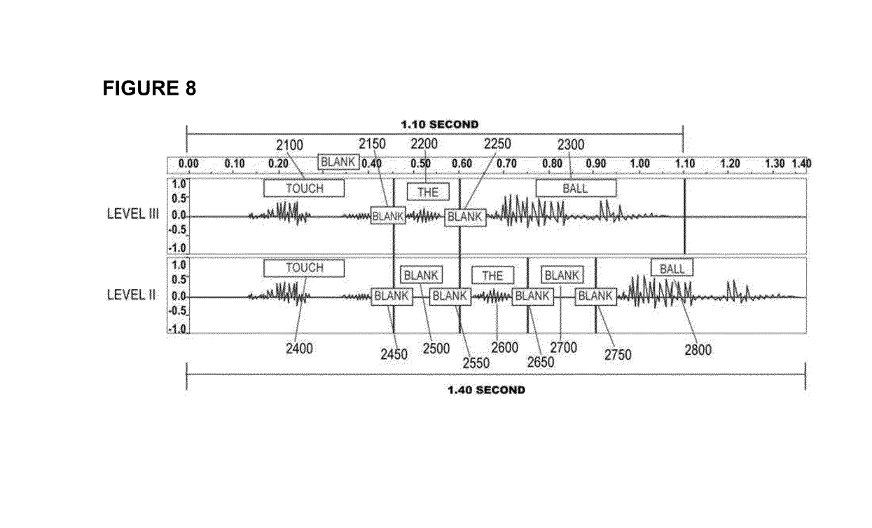

Reference is then made to FIG. 8 that illustrates the method of customization of sound for lower level skill. The instructional and informative educational audio gets stored in the database in pieces like TOUCH 2100, THE 2200 and BALL 2300. For Level III the voice will be the natural voice which will have each word separated by 0.06 seconds. The BLANK 2150 indicates default separation of 0.06 seconds between two words. For the lower level complexity of Level II and Level I, additional BLANK 2500 and BLANK 2700 are inserted to make the information easy to understand for the subject. These additional BLANK (2500 and 2700) are of 0.1 seconds. FIG. 8 illustrates Level III and Level II examples. FIG. 8 illustrates, by utilizing this method the original time span for the “TOUCH THE BALL” will get extended from the 1.10 seconds to 1.40 seconds.

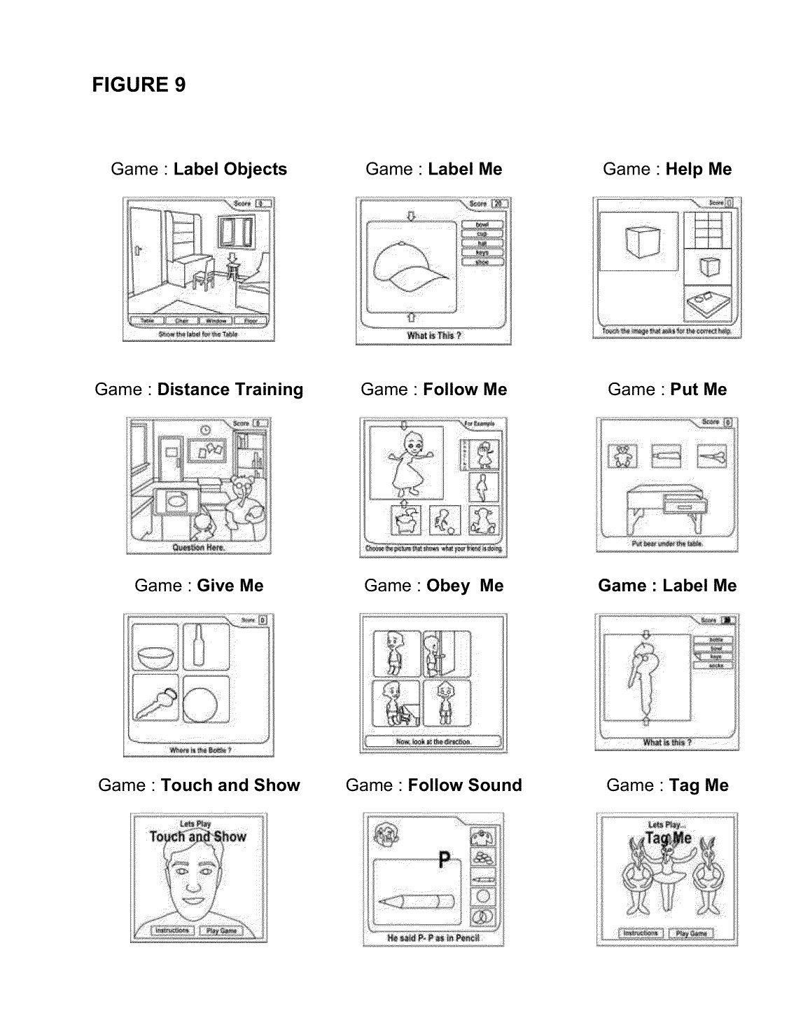

Reference is then made to FIG. 9 that illustrates pictorial presentation of some of the sample activities. Listed screens show activities of Label Objects, Label Me, Help Me, Distance Training, Follow Me, Put Me, Give Me, Touch and Show, Follow Sound and Tag Me.

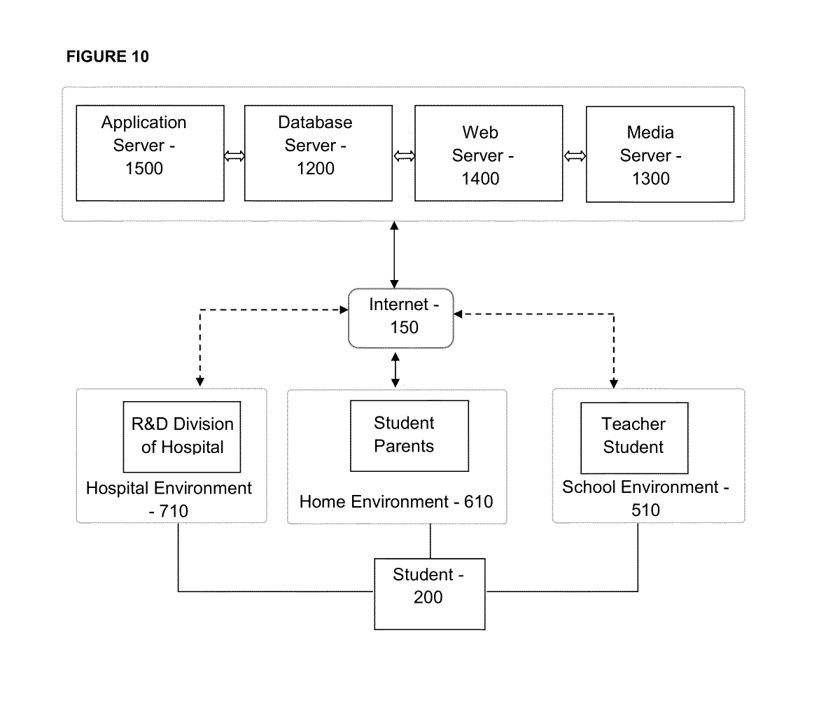

Referring to FIG. 10 that illustrates the utilization of the system and how the same subject uses the same Activity Modules from different locations by utilizing different hardware. The subject 200 uses the same database server 1200 and media server 1300 to get the training from different locations and populate the data in a centralized place in a data center 900.

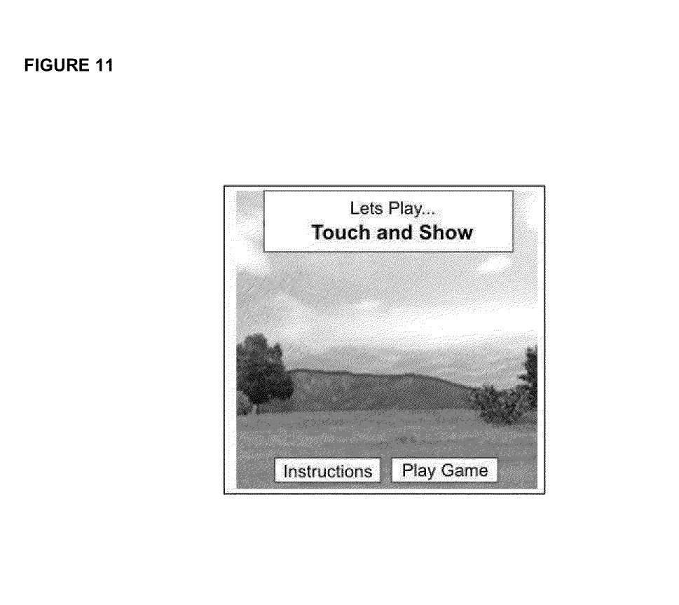

FIG. 11 illustrates a sample activity “Touch and Show” title screen. Based on the subject's skill level when the activity gets loaded, the first screen shows the activity title screen. For the level I, activity and the training is automatically loaded in full screen and subject would not have to click on the options shown in the FIG. 11. For the Level II and Level III users the ‘Title Screen’ as shown in the FIG. 11 will be displayed. The subject has to click or touch on the ‘Play’ button to start the activity.

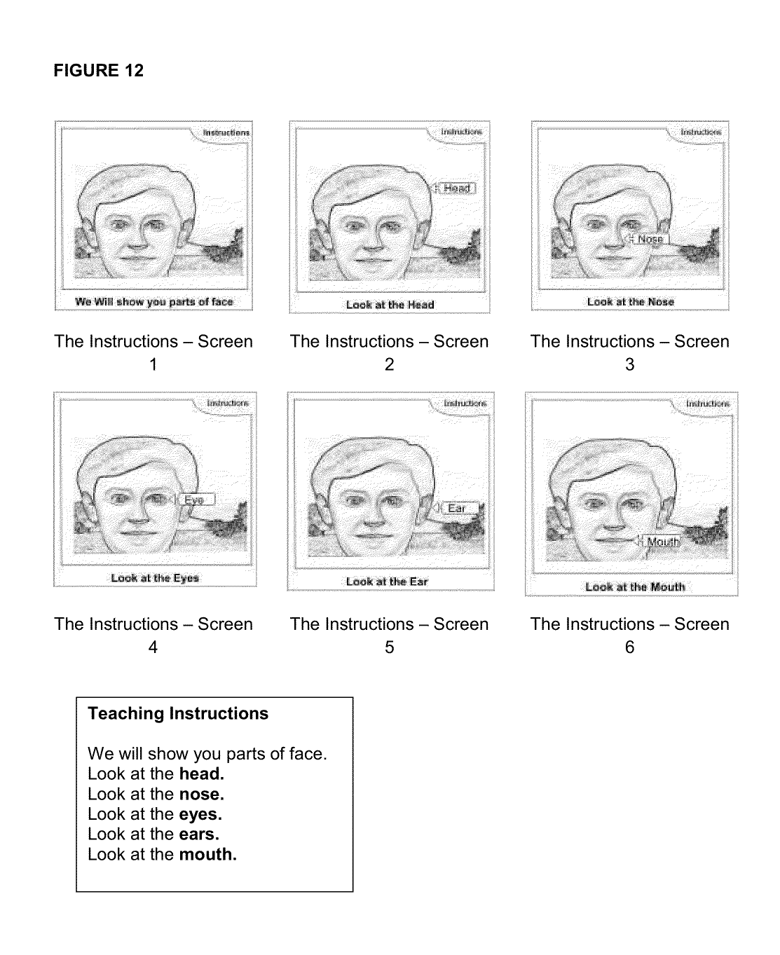

FIG. 12 illustrates teaching instructions on training to the subject for the topic of training for a sample activity “Touch and Show”. Before the activity begins, the animated training is provided to the subject using the audio visual presentation of the topic of training. FIG. 12 illustrates teaching Instructions Examples; Screen 1 illustrates how different parts of the face are shown to the subject. The audio instructions are delivered in the screen 1 to the subject along with the visual instructions using text. Screen 2 illustrates how the body part is highlighted and audio instruction “Look at the head” is delivered to the subject. Screen 3 illustrates the nose highlighted with arrow, the audio “Look at the nose” and visual instructions delivered to the subject. Screen 4, Screen 5 and Screen 6 illustrates other body parts for training.

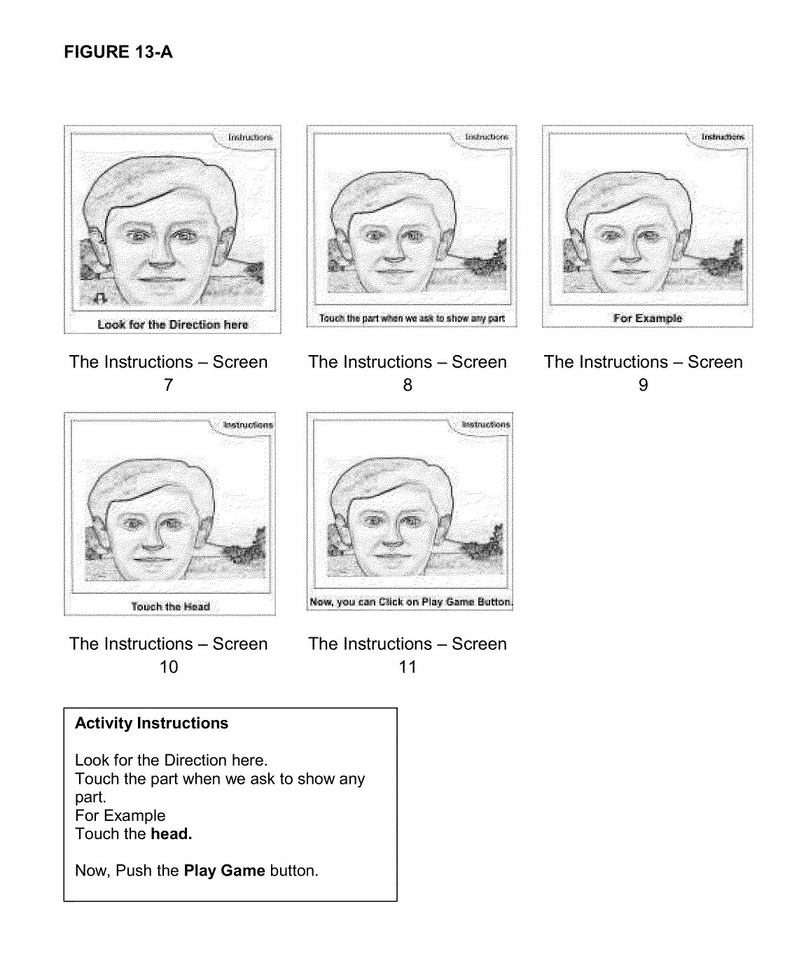

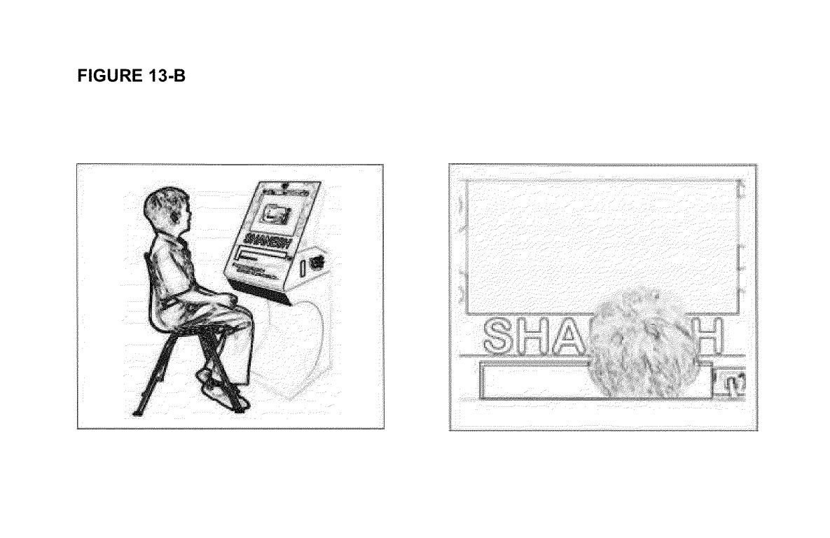

FIG. 13 illustrates activity training instructions on how to carry on the activity using the computer and touch screen monitor for a sample activity “Touch and Show”. Screen 7 illustrates where the directions are displayed with audio “Look for the Direction here” with text based instruction. Screen 8, 9, 10 and 11 illustrates instructions on how to respond to the activity. These instructions are delivered using visual and audio presentation to the object using text on the screen.

FIG. 13-B illustrates activity training instructions screens on how to carry on the activity using the computer and touch screen monitor for a sample activity “Touch and Show”. These instructions are delivered to the subject using different model of visual presentation with audio delivered in an animated video form where the example of the actual user is visually shown playing and following instructions and responding to the activity. In this method of the training, the example shows the child playing the activity and following instructions.

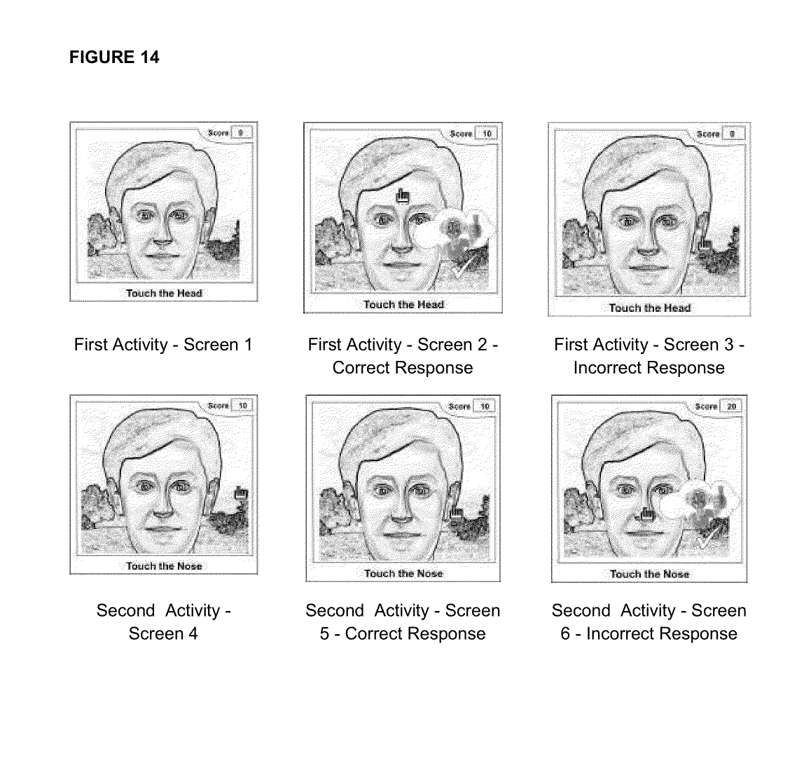

FIG. 14 illustrates the sample activity “Touch and Show”. Screen 1 illustrate the questions asked to the subject and screen 2 shows how the correct answer is recognized by encouraging animation with audio visual effect. Screen 3 illustrates how the incorrect answer is ignored and the next activity is delivered without any negative response from the training. In the example, the instruction to carry out the first activity—Touch the Head—is shown at the bottom. As shown in FIG. 14 when the subject responds correctly—(a) an animation cheering the player is played and (b) the score points are incremented by a preset value. If the student is unable to finish the activity successfully then an audio message is played. The procedure to carry out the second or remaining number of activities stays same as that of the first activity. FIG. 14 portrays procedure to carry out the second activity—Touch the Nose. The Instructions for remaining activities in this example are—Touch the Eye, Touch the Ear, Touch the Mouth.

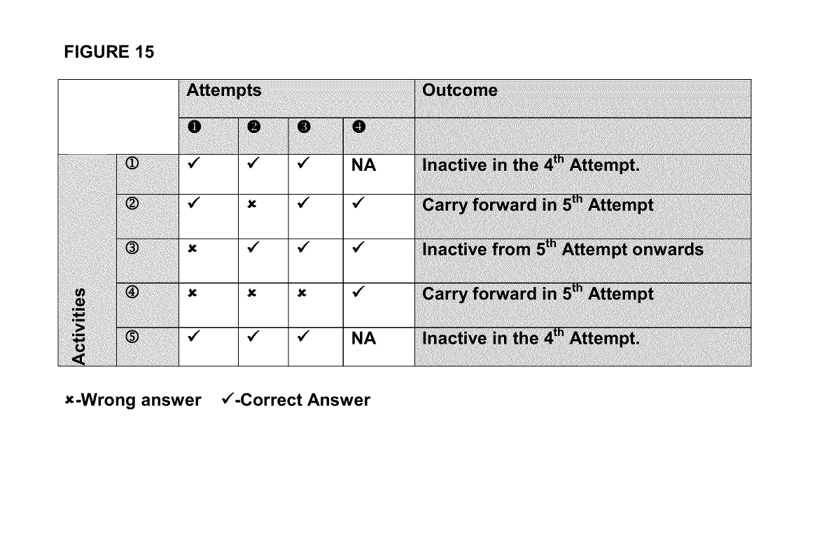

Reference is then invited to FIG. 15 that illustrates example of attempts taken by the subject to complete the sample activity “Touch and Show”. A student successfully completes an Activity, if—1) all activities in the module are mastered or 2) the completion criteria are met. An activity is mastered if the criteria as set by the instructor are satisfied. In the example, there are 5 numbers of activities. Each activity is mastered upon 3 times correct responses provided by the subject. Table 1 illustrates few sample cases. Each column from the second column onwards illustrates an attempt. First column contain the number of activity. The attempts and activities in a row form a case. The outcome in each case is shown in the last column. If there are 3 consecutive correct responses to an activity, it is removed from the assigned activity list on subsequent attempts. Table 1 illustrates Sample Cases where assigned activities are five and the number correct response expected from the subject for each activity is three. After three successful correct answers the activity gets removed from the activity module. As can be seen from the first row of the table since there are 3 consecutive correct responses to Activity 1, this activity is removed from 4^{th} Attempt onwards. Same is the case with Activity 5. The outcome for all the cases is put in the Outcome column.

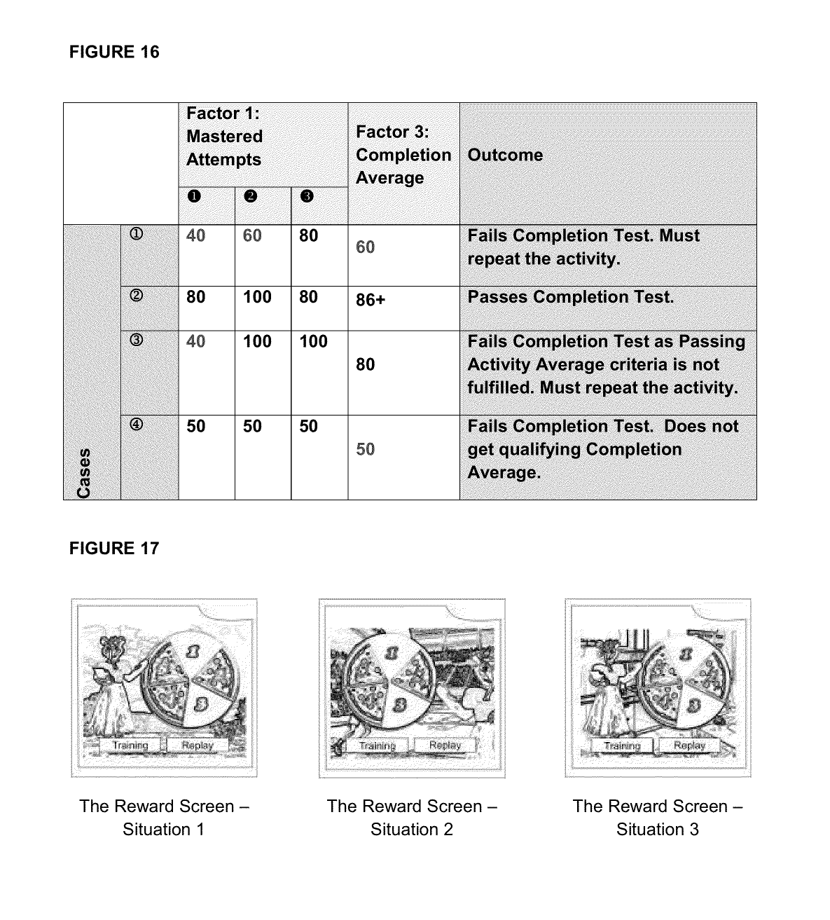

Reference is then invited to FIG. 16 that illustrates how the score is tracked for the successful completion of the assigned module to the subject. In all, there would be as many attempts as required to master all the 5 assigned activities. An average in percentage of these attempts is recorded. This is the Activity Average score. The completion criteria include three factors—Factor 1: Number of Mastered Attempts to be tracked, Factor 2: Passing Activity Average in Percentage, Factor 3: Qualifying Completion Average in Percentage. The example assumes the value for factor 1 is 3 and that for factor 2 is 50 and factor 3 is 80.

Referring to FIG. 17 illustrates the reward screen at the end of the activity module. The score points or rewards achieved are presented displayed in a graphical form. FIG. 4 show ‘Reward Screens’ under various situations. The accompanying animation explains the rewards obtained for each successful activity. In this example, the subject gets one pizza slice for each correct response. Since the activities 2, 4 and 5 are successfully completed, the cumulative count is 3. The replay button starts the activity all over again. The training button replays the training part once again.

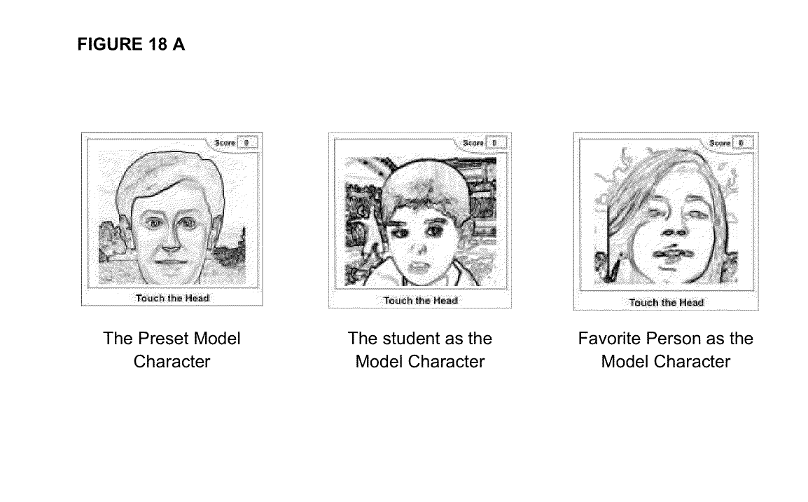

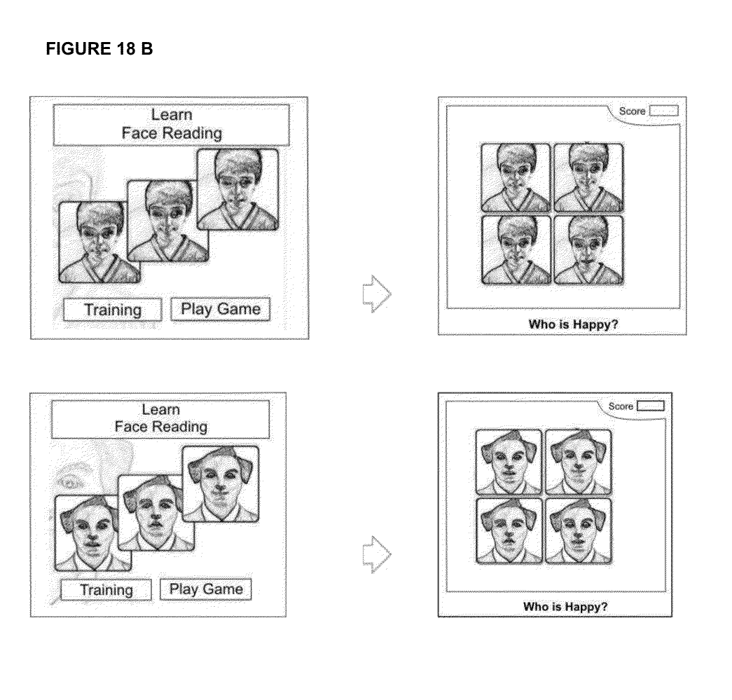

FIG. 18-A illustrates an example of how the activity gets customized by the Trainer Administrator based on the student's likings. Each activity module can be customized to suit an individual's preferences and needs. For example if the subject has an affinity for sports Tennis, the background can be set to that of a tennis court. FIG. 18 illustrates different backgrounds with different object for the same activity. Once the student has mastered the activity in the existing set up, the set up can be changed by the Trainer Administrator. This method is utilized to assess student's performance in diverse environment. For example, the model character in this activity module can be—(a) The Preset picture of a character, (b) subject themselves or (c) one of subject's favorite person. FIG. 18-B illustrates an example of an activity where the image in the activity is replaced by the system with the image or photo of the computer generated character or actual picture of the person based on the subject's likings.

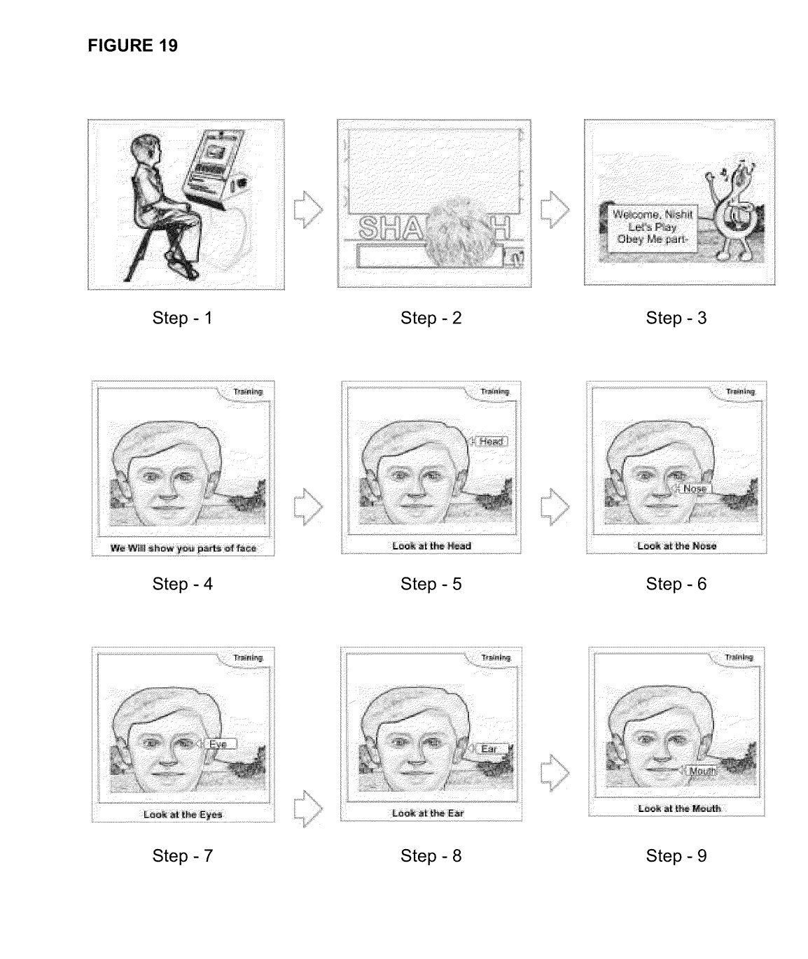

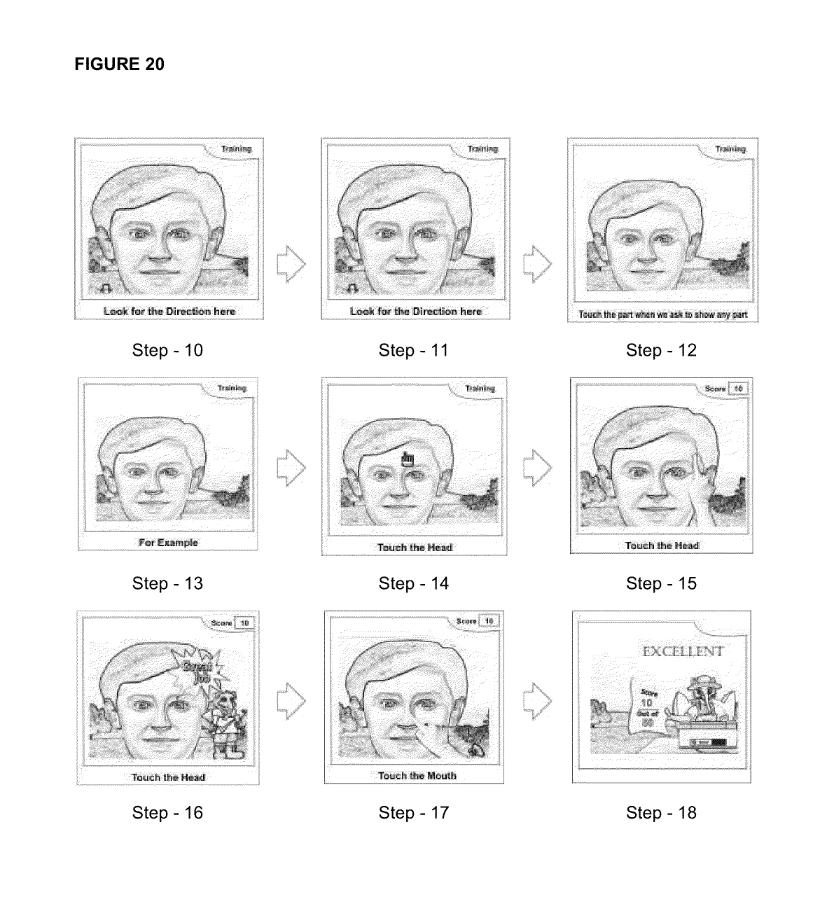

Reference is then invited to FIG. 19 and FIG. 20 that illustrates the step by step actions performed by the subject to complete the assigned activity on the Kiosk based touch screen system. Step 1 illustrates the subject sitting in front of the kiosk system. Step 2 illustrates the subject validating the access to the system using finger print scanning device. Step 3 shows the introductory entertaining animated content with audio is delivered to the subject. Step 4 to Step 14 illustrates the training material delivered to the subject using the visual and audio presentation of the content. Step 15 to 17 illustrates the actual activity attended by the subject and step 18 illustrates the animated result score presented to the subject.

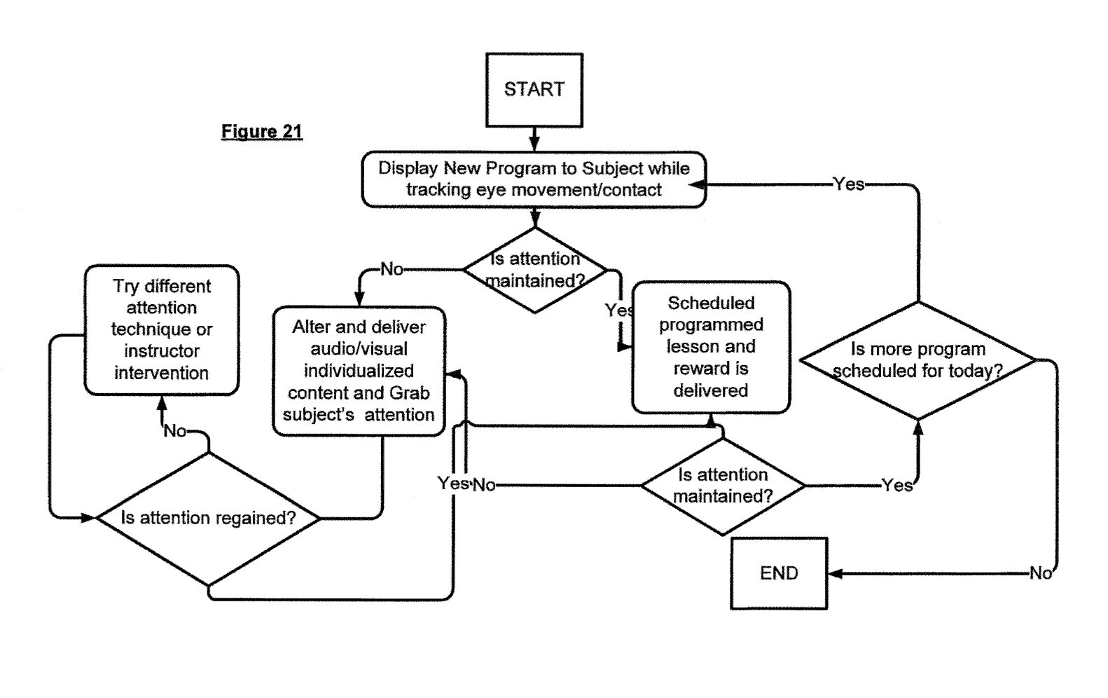

FIG. 21 shows an additional embodiment of the disclosed method and system that can be employed in combination with the previously disclosed elements. Included in the system embodied in the flowchart of FIG. 21 is an eye tracking unit for tracking eye movement of the Subject on the display. The eye tracking unit may include any known technology for tracking eye position and movement, preferably non-invasive technology. A suitable technology includes video oculography, which measures or senses light reflected from the Subject's eye (typically a corneal reflection, i.e., Purkinje eye tracking) with a video camera or other optical sensor. The measured reflection data is analyzed to calculate eye rotation (and location of focus). Another suitable technology is the dual-Purkinje eye tracker which uses reflections from both the front of the cornea and rear of the lens. Bright pupil and dark pupil techniques may be employed for eye tracking.

Eye tracking technology may be employed as an alternative or additional feedback source, i.e., in place of or in combination with touch screens, haptic feedback or any of the additional feedback methods discussed herein. Lesson plans may cooperate with eye tracking technology in terms of providing audio-visual instructions for the Subject to look at a particular object or location on the display. Further, eye tracking is utilized to more accurately observe and measure a Subject's attention span on the audio-visual content or lesson. For example, if eye tracking data indicates that the Subject's attention is not on the display, the content delivered to the display can be altered to deliver appropriate individualized content designed to recapture the Subject's attention, whereupon the lesson plan may be restarted. Like the previous embodiments, the eye tracking data and audio-visual information and observations are available remotely to a Trainer Administrator streaming in real-time and also may be recorded for later analysis. The alteration of content delivered to the display may be initiated automatically or by an observer, such as a Trainer Administrator from a remote location. Attention reclaiming audio-visual content may vary according to the individual Subject's likings and personality. Individualized audio-visual prompts may also be delivered to focus the Subject's attention back to the educational audio-visual content, which is restarted once eye contact is detected by the eye tracking unit. For example, the Subject's name can be exclaimed from the audio source.

The Subject's eye movements may also be tracked and used to detect the location of the area of the attention on the screen. Utilizing the information gathered and observed, the audio visual prompts may be also readjusted. Based on the focused area on the screen the additional audio-visual support will be provided to the subject for more effective intervention.

As with the above embodiments, feedback from the eye tracking and delivered content is recorded in a database and observable at a remote location in real time or observable as a recording.

The eye tracking capabilities of the system may also be employed as a testing technique, whereby instructions to look at a certain object or location on the display and the Subject's eye movement response is tracked to determine whether the instructions are followed. When the eye tracking identifies an incorrect location or answer, the program may deliver an additional audio-visual clue or instructions to assist the Subject in identifying the correct answer. Alternatively, when the correct answer or location is detected, an audio-visual congratulatory message may be displayed and/or reward delivered to the Subject.

The disclosed system may include an automatic or third-party initiated “shutdown” feature to shut down or freeze the program for emergency and immediate changes for individualizations to the Subject. The individualized shutdown feature is configured based on the Subject's behavioral personality and may include animations, shutdown warnings or countdowns on the display. The emergency “shutdown” may simply include a lockout of touch screen capabilities to the Subject, which is typically initiated when a Subject is observed via video monitoring or eye tracking to not be following instructions.

An additional embodiment employs a secondary display viewable by the Subject. The secondary display may involve altering the ambiance of the room in which the Subject is receiving a lesson, such as colored LEDs on a wall of the room, digital images projected on the wall or secondary monitor. The ambiance of the room or secondary display may be initiated automatically in response to feedback from the Subject (observed or measured), may be used as an alternative or in addition to a physical reward, or may be used to attempt to regain the Subject's attention to a lesson. In this manner, the whole learning environment may be individualized and working together as a reward and for instructions.

A timed lesson has been found to be particularly advantageous to building attention span and subsequent learning capacity. The timed lesson may be employed with any of the Subject feedback mechanisms disclosed herein, but has been found to be especially effective with eye tracking feedback systems. A target time T₁ for the Subject's attention is initially set by the Trainer Administrator or automatically by the program. A second length of time T₂ is then set which is shorter than the target time. A program of audio-visual content is initiated on the display to the Subject while tracking the Subject's eye contact. If an absence of Subject eye contact on the display is detected (indicating a loss of attention) prior to the target time T₁ being reached, a reward or individualized visual stimulation is delivered to the Subject at a time represented by the target time T₁ less the second time T₂ to promote restore the Subject's attention to the display, whereupon the lesson may be restarted. The times T₁ and T₂ are independently lengthened or shortened as appropriate as progress in terms of the Subject's attention span is observed or detected.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. An interactive audio-visual method for training cognitive, language or social skills of a subject, comprising:
a) providing a display viewable by a subject at a first location;
b) providing a predetermined lesson to the subject by presenting audio-visual animated content to the subject via the display while detecting the location of the subject's attention on the display via eye tracking technology;
c) altering the audio-visual content on the display to initiate a predetermined redirection of the subject's eyes to a different position on the display;
d) progressively altering the audio-visual content on the display in response to feedback from tracking of the subject's eye movement in response the altered content;
e) optionally delivering a reward to the subject upon successful completion of the predetermined lesson, wherein
the audio-visual content and progressive alteration thereof is individually tailored in terms of one or both of the subject's interest and skill level, and the content provided on the display and eye tracking data is viewable by a trainer administrator at a second location via streaming video over a network connection.

2. The method of claim 1, wherein the content provided on the display and eye tracking data is viewable by the trainer administrator in real time.

3. The method of claim 2, comprising the step of allowing the trainer administrator to initiate a particular alteration of the audio-visual content delivered to the subject via the display.

4. The method of claim 1, comprising the step of recording the audio-visual content delivered and the responsive eye tracking data of the subject.

5. The method of claim 1, wherein step (d) includes altering the audio-visual content to individualized content configured to gain the subject's attention if feedback from eye tracking indicates a loss of attention by the subject.

6. The method of claim 1, wherein step (d) includes delivery of audio or visual instructions to the subject to relocate its eye contact to a different target position on the display and optionally repeating the audio or visual instructions in response to feedback from eye tracking technology indicating that the subject's eye contact failed to reach the target position.

7. The method of claim 1, wherein the reward is selected from one or more of the group consisting of a physical object, food and audio-visual response.

8. The method of claim 7, wherein the reward includes an audio-visual response that is independent from the display.

9. The method of claim 1, wherein the display includes a touch screen input, the audio-visual content includes instructions for the subject to touch the screen at one or more locations and the subject's touch responses thereto are delivered to the second location over the network connection.

10. The method of claim 9, wherein step (d) includes altering the audio-visual content in response to the subject's touch responses to the instructions.

11. The method of claim 9, comprising the step of automatically locking the touch screen capability in response to detection of the absence of eye contact on the display for a predetermined period of time.

12. The method of claim 1, comprising the step of introducing audio-visual content to the subject on a second display in response to feedback from eye tracking.

13. The method of claim 1, including the steps of:
(i) setting a predetermined target duration of time of eye contact on the display by the subject;
(ii) monitoring duration of the subject's eye contact on the display using the eye tracking technology while providing predetermined audio-visual content on the display;
(iii) altering the audio-visual content in response to detecting a loss of eye contact on the display prior to the target duration being reached;
(iv) repeating step (iii) as applicable; and
(v) delivering a reward to the subject in response to detecting a maintenance of eye contact on the display for the entire target duration.

14. The method of claim 1, including the steps of:
(i) setting a predetermined target duration of time of eye contact on the display by the subject;
(ii) setting a second predetermined length of time that is shorter than the target duration;
(iii) monitoring the subject's eye contact on the display using the eye tracking technology while providing predetermined audio-visual content on the display; and
(iv) delivering a reward to the subject at a point in time represented by the target duration less the second predetermined length of time.

15. An integrated system for training cognitive, language or social skills of a subject and monitoring progress thereof by a system administrator, comprising:
an first output unit comprising a visual display and audio output for delivering audio-visual content to the subject, the first output unit being positioned in a first location;
an eye tracking unit proximate the first output unit configured to monitor the subject's eye movement and location along the visual display;
a second output unit positioned in a second location configured to deliver content and data to the trainer administrator;
a control unit configured to receive an input and being accessible to the trainer administrator at the second location;
a storage unit comprising a computer readable data storage device for recording data associated with delivery of audio-visual content to the first output unit and corresponding monitoring of eye movement by the eye tracking unit;
a communication line connecting the first output unit and eye tracking unit to the second output unit and storage unit, wherein
the communication line allows recording of data in the storage unit and monitoring of the audio-visual content delivered to the subject via the first output unit and corresponding eye tracking data by the system administrator, and initiation of changes in the audio-visual content delivered via the first output unit by input at the control unit by the system administrator in real time.

16. The system of claim 15, comprising a reward delivery unit positioned at the first location for delivery of a reward to the subject, wherein delivery of a reward may be initiated by input at the control unit.

17. The system of claim 15, comprising a third output unit at the first location, the third output unit being independent from the first output unit and configured to deliver audio-visual content to the subject.

18. The system of claim 17, wherein the third output unit is selected from one or more of the group consisting of a projector, LED lights, display screen and audio speaker, wherein the projector and LED lights are configured to display visual images or colors on at least one wall at the first location.

19. The system of claim 15, wherein the communication line is a network connection and the second output unit is a web-based interface.
